(19) United States
(12) Patent Application Publication
(10) Pub. No.: US 2003/0151172 A1
(43) Pub. Date: Aug. 14, 2003

(54) Apparatus and method for forming discrete hollow parts

(76) Inventors: Greg Floyd, Wooster, OH (US); Erik Skov, Akron, OH (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/324,394

(22) Filed: Dec. 20, 2002

Related U.S. Application Data
(60) Provisional application No. 60/345,108, filed on Dec. 21, 2001.

(51) Int. Cl. B29C 51/02; B29C 51/20

(52) U.S. Cl. 264/572; 425/233; 425/326.1; 425/392; 425/388; 425/290; 264/285; 264/295; 264/157

(57) ABSTRACT

A method for continuously forming discrete hollow parts includes extruding at least one continuous stream of molten plastic. A plurality of mold segments are arranged such that one or more segments periodically close on the one or more streams of molten plastic and define discrete part forming cavities when closed. A pressure differential is created within the discrete part forming cavities to shape the molten plastic accordingly. Air or another gas is replenished within the discrete hollow parts either in the discrete part forming cavities, or nearly immediately upon discharge from the cavities. The discrete hollow parts are then cooled. The apparatus for forming discrete hollow parts in this manner has an extruder and a plurality of the mold segments including one or more segments that can be closed on the plastic stream or streams. The pressure differential is applied by the apparatus to the closed mold segments. The hollow part interior is replenished either by the apparatus or manually by an operator. The parts can be cooled by a part of the apparatus or downstream of the apparatus.

### FIELD OF THE INVENTION

The invention is generally related to plastic product forming operations, and more particularly to apparatuses and methods for continuously forming discrete hollow parts.

### BACKGROUND OF THE INVENTION

There are many plastic products or components that have a complex shape or that are assembled from one or more interconnected complex shaped components. Many of these components and products have either a hollow interior or a large interior space. Many of these hollow parts also have exterior shapes with complex contours, multiple surface planes, undercuts, curves, and the like. A few examples of hollow components include plastic coolers and lids, hollow plastic panels, playground-type slides, sleds, and the like. Examples of components having a large interior space are refuse cans and plastic storage containers. The hollow interior or interior space of these types of components can include only air. Alternatively, the interior can sometimes be partly or completely filled with a secondary material or can house a secondary inner component to improve insulation properties, strength characteristics, and/or affect weight considerations as desired.

To manufacture such products is fairly expensive and time consuming. It is common to form such hollow plastic products and components using high pressure injection molding, blow molding, spin or rotation molding, slush molding, or the like. However, each such process is limited to forming discrete or individual parts separately using individual mold cavities and discrete molding cycles. The tools or mold sections are fabricated from steel, aluminum, or other relatively high strength, durable, and temperature resistant material. Each mold section is typically machined either manually or by an automated CNC machining process. The mold sections are formed having separate cavities for forming one or more component parts sections or complete product sections.

These types of processes can produce only a finite number of discrete products or components during a given cycle. A cycle must be repeated to produce additional parts or components. Each cycle typically involves first preparing the mold sections which can include pre-heating or cooling the mold, adding inserts or decorations, closing mold halves, or the like. A plastic material may then be introduced to the one or more discrete mold cavities. The plastic material may be molten plastic prior to introduction to the mold, or may become molten after introduction. Depending upon the process used, the plastic is conformed to the surfaces of the mold cavity. The molds are then opened and the discrete parts removed from the mold, cooled, and trimmed if necessary.

Each cycle produces only a finite number of discrete parts, even if a quantity of separate parts are formed together in the same cavity or the same mold. The complete cycle must be repeated each time more parts are produced. The process of preparing the molds and repeating the cycles is time consuming. Downtime between successive cycles can produce fairly significant manufacturing cost and time disadvantages. Other problems can include process variability, increased scrap material and/or parts, and part dimensional or tolerance variation.

Processes are known for continuously fabricating plastic components that have a simple or repetitive exterior shape. One example of such a process is extrusion where a continuous length of material is extruded. The continuous length can be cut to form discrete components. However, an extrusion process does not permit longitudinal size or shape variation in the finished parts.

A process is known for continuously producing corrugated plastic pipe. This process and many of the machine components involved are disclosed in a number of patents including, for example, U.S. Pat. Nos. 5,059,109; 5,494,430; and 5,645,871, which are assigned to Cullom Machine Tool & Die, Inc. of Cleveland Tenn. Other exemplary patents that are related to this process are U.S. Pat. Nos. 4,319,872; 4,439,130; and 4,718,844.

The corrugated pipe produced by this process is a cylindrical, endless tube with circumferential corrugations. Thus, the pipe does vary in size and shape longitudinally. The process generally includes extruding a tube of a thermoplastic material through a die and subsequently conforming the extruded tube to form corrugations or other surface contours in the tube. The tube is passed from the die into what is known as a mold tunnel formed by a plurality of mold blocks that move in concert with the extruded tube.

The mold blocks most often come in pairs and close on one another to define the mold tunnel. A vacuum applied is at the mold cavity surfaces or a positive air pressure is applied within the tube to conform the tube to the shape of the corrugation mold blocks. The wall contour of the pipe is typically symmetrically corrugated, but the pipe can also be formed having smooth walls or other repeating surface irregularities or contours. This pipe forming process is to date only suited for molding continuous length, open ended pipe. Also, the process typically is arranged such that the extruded tube is oriented horizontally while the corrugations are being formed, although it can be oriented vertically.

U.S. Pat. No. 3,519,705 discloses a vertical extruding apparatus for forming molded products.

None of the above processes have heretofore been adapted or suited for producing discrete length hollow products or discrete length, hollow, closed end parts.

### BRIEF DESCRIPTION OF THE DRAWINGS

Exemplary apparatuses and methods for forming discrete hollow parts in accordance with the teachings of the present invention are described and explained in greater detail below with the aid of the drawing figures in which:

FIG. 1 is a front schematic view of an apparatus for continuously forming discrete hollow parts in accordance with the teachings of the present invention.

FIG. 2 is a front schematic view of an alternative apparatus for forming discrete hollow parts in accordance with the teachings of the present invention.

FIG. 3 is a front view of one example of a part forming section of the apparatus shown in FIG. 1.

FIG. 4 is a side view of the part forming section shown in FIG. 3.

FIG. 5 is a side view of another example of a part forming section of the apparatus shown in FIG. 1.

FIG. 6 is a front view of the part forming section shown in FIG. 5.

FIG. 7 is a front view of another example of a part forming section of the apparatus shown in FIG. 1.

FIG. 8 is a side view of the part forming section shown in FIG. 7.

FIG. 9A is a side view of another example of a part forming section that includes a plurality of different mold segments.

FIG. 9B is a simplified view of a portion of a pat chain formed using the part forming section shown in FIG. 9A.

FIG. 10 is a plan view of a continuously formed chain of discrete hollow parts and illustrating a variety of different part interconnection joint examples.

FIG. 11 is a side view of the part chain shown in FIG. 10.

FIG. 12 is an enlarged plan view of an alternative interconnection joint 15 between two discrete hollow parts of a part chain.

FIGS. 13A-13C are various cross section views of the joint shown in FIG. 12.

FIG. 13D is a cross section of a joint similar to that illustrated in FIGS. 13S-C, except that it is a closed end discrete hollow part in and of itself.

FIG. 14 is a cross section front view of one example of a cooling section of the apparatus shown in FIGS. 1 and 2.

FIG. 15 is a cross section front view of another example of a cooling section of the apparatus shown in FIGS. 1 and 2.

FIG. 16 is a cross section front view of another example of a cooling section of the apparatus shown in FIGS. 1 and 2.

FIG. 17 is a cross section of one example of an extrusion die in accordance with the teachings of the present invention for the apparatuses shown in FIGS. 1 and 2.

FIG. 18 is a plan view of one example of a mold segment and part forming cavity in accordance with the teachings of the present invention for use with the die shown in FIG. 17.

FIG. 19 is a plan view of another example of a mold segment and part forming cavity in accordance with the teachings of the present invention for use with the die shown in FIG. 17.

FIG. 20 is a plan view of one example a plurality of adjacent mold segments and part forming cavities in accordance with the teachings of the present invention for use with the die shown in FIG. 17.

FIG. 21 is a cross section of another example of an extrusion die in accordance with the teachings of the present invention for the apparatuses shown in FIGS. 1 and 2.

FIG. 22 is a plan view of a mold segment and part forming cavities in accordance with the teachings of the present invention for use with the die shown in FIG. 21.

FIG. 23 is a plan view of another alternative example of a mold segment and part forming cavity in accordance with the teachings of the present invention.

FIG. 24 is an end view of the mold segment shown in FIG. 23.

FIG. 25 is a cross section of the mold segment shown in FIG. 23 and taken along line XXV-XXV.

FIG. 26 is a cross section of an alternative mold segment and part forming cavity in accordance with the teachings of the present invention.

FIG. 27A is a longitudinal cross section through one example of an open ended discrete hollow part in accordance with the teachings of the present invention that can be formed by the apparatuses shown in FIGS. 1 and 2.

FIG. 27B is an end view of one example of an open ended discrete hollow part such as is shown in FIG. 27A.

FIG. 27C is an end view of another example of an open ended discrete hollow part such as is shown in FIG. 27A.

FIG. 28A is a longitudinal cross section through one example of a closed end discrete hollow part in accordance with the teachings of the present invention that can be formed by the apparatuses shown in FIGS. 1 and 2.

FIG. 28B is an end view of the closed end discrete hollow part shown in FIG. 28A.

FIG. 29 is a longitudinal cross section of another example of a discrete hollow part in accordance with the teachings of the present invention that can be formed by the apparatuses shown in FIGS. 1 and 2.

FIG. 30 is a cross section of another example of a discrete hollow part constructed in accordance with the teachings of the present invention.

FIG. 31 is a cross section of another example of an extrusion die in accordance with the teachings of the present invention for the apparatuses shown in FIGS. 1 and 2.

FIG. 32 is a partial cross section of another example of a mold segment and discrete hollow part constructed in accordance with the teachings of the present invention.

FIG. 33 is a partial cross section of another example of a mold segment and discrete hollow part constructed in accordance with the teachings of the present invention.

### DETAILED DESCRIPTION OF THE PREFERRED EMBODIMENTS

The apparatuses and methods disclosed herein in accordance with the teachings of the present invention are generally for continuously forming discrete, substantially hollow parts including open or closed end products. Generally, the process includes extruding molten plastic through a die and passing the plastic extrudate or stream between moving mold segment pairs. The mold segment pairs define part forming cavities when the segment pairs are closed on the plastic stream. A pressure differential is applied within the closed cavities to conform the plastic material to a contour of the cavity. Air within the hollow parts is replenished to prevent the opposed walls of the parts from collapsing onto themselves. The formed plastic material is then cooled. The methods and apparatuses are capable of producing discrete hollow parts having an endless variety of different shapes and sizes. The discrete hollow parts can have either open ends, partially open ends, or completely closed ends. Alternatively, the parts can be formed having closed ends that become open ended in some form after a trimming process.

As used herein, the term “hollow” is intended to encompass a number of various part or component constructions. First, “hollow” as used herein is intended to include a component that has a completely enclosed interior space of hollow. However, “hollow” as used herein is also intended to encompass substantially hollow parts or components that have a substantially enclosed interior but not necessarily an entirely enclosed interior. In other words, a “hollow” part within the context of this disclosure may also have one or more openings in one or more ends or surfaces of the part. Also, parts or components can be formed having two or more separate pieces that are initially formed integral with one another and later separated from one another. Though the one or more separate pieces may not be “hollow,” as defined herein, after separation from one another, the initial integral piece is substantially hollow within the context of this disclosure. Further, the separated pieces may be completely unrelated to one another, may be identical to one another, or may be related to one another as parts of an assembly or the like.

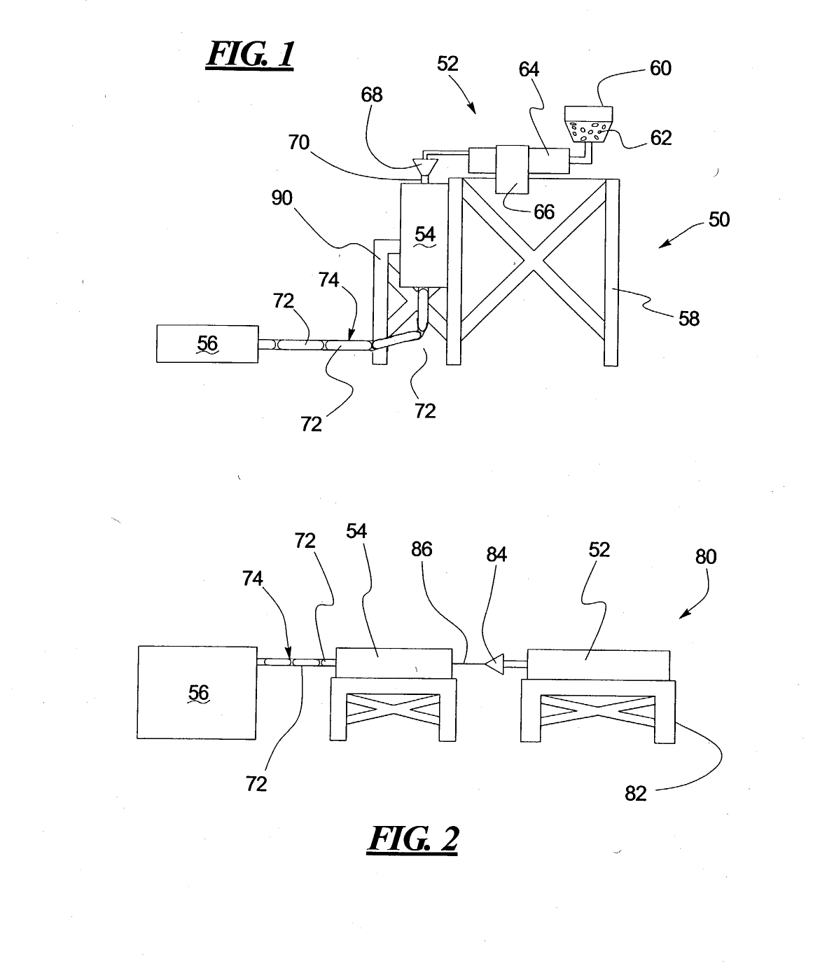

Referring now to the drawings, FIG. 1 illustrates a front schematic view of an apparatus 50 constructed in accordance with the teachings of the present invention. The apparatus 50 generally has an extrusion section 52 and a forming section 54. As is described in greater detail below, the apparatus 50 can also have a stand alone cooling section 56 arranged downstream of the forming section 54, if desired, for a particular part forming process. Alternatively, the parts can be cooled within the forming section 54, also as described below.

The apparatus 50 generally has a frame structure 58 supporting various components of the apparatus above a ground surface. The extrusion section 52 of the apparatus 50 generally has a hopper 60 into which raw plastic material 62 is dumped and, if necessary, mixed. The raw material 62 is passed to a heating region 64 generally illustrated in FIG. 1. A controller 66 is provided as part of the apparatus 50, in part for controlling and monitoring various parameters of the extrusion section 52. The raw material 62 is heated and melted in the heating region 64 to an appropriate temperature, depending on the particular extrusion process and plastic material being utilized to produce specific parts. Molten plastic is passed from the heating region 64 to an extrusion die 68. The die has an outlet configuration designed to produce an extrudate or molten plastic stream 70 having particular characteristics.

The characteristics of the stream 70 exiting the die 68 can be altered by changing, for example, the die orifice parameters, plastic material, extrudate temperature, or the like, as is known to those having ordinary skill in the art. In one example, the die 68, and particularly the die orifice, can be fitted with a programmable die head which is known in standard blow molding operations. A movable piston in the die head can be manipulated to alter the die gap for controlling part wall thickness or the like. The controller 66 can be adapted to control the die head parameters as needed, as well as other molding parameters.

The molten plastic stream 70 is delivered to the forming section 54, which is described in greater detail below. A plurality of interconnected discrete hollow parts, identified generically herein as parts 72, exits the forming section 34 as a continuous interconnected chain 74 of the parts. As noted above, the chain 74 of the parts 72 can be passed through a separate cooling section 56, if desired for a particular process and apparatus 50.

The apparatus 50 as shown in the example of FIG. 1 is arranged in an orientation known as a vertical extruder, wherein the molten plastic stream 70 is dropped vertically to the forming section 54. In this example, the continuous chain 74 of interconnected parts 72 exits vertically downward from the forming section 54.

As illustrated in FIG. 2, another example of an apparatus 80 is shown and which is constructed in accordance with the teachings of the present invention. The apparatus 80 has essentially the same extrusion section 52 as shown in FIG. 1, but is shown only generically in FIG. 2. The extrusion section 52 is supported by a lower elevation frame structure 82 in this example. Also, a die 84 provides a generally horizontal molten plastic stream 86. In this example, the extruded stream 86 is oriented and travels horizontally. The stream 86 is passed through a horizontally oriented forming section 88, supported by a frame structure 82, that produces a continuous chain 74 of interconnected parts 72. Again, the chain 74 can subsequently pass through a cooling section 56, if needed and desired. The apparatus as shown in the example of FIG. 2 is arranged in an orientation known as a horizontal extruder.

The components of the extrusion section 52 described above can vary considerably and yet fall within the scope of the present invention. The heating section 64, the controller 66, the hopper 60, and the various electrical and pneumatic wires, lines, conduits, couplings, miscellaneous sundry parts, and their variations are known to those having ordinary skill in the art. Similarly, the arrangement of these components and the frame structures 58 and 82 supporting these components can also vary considerably and yet fall within the scope of the invention.

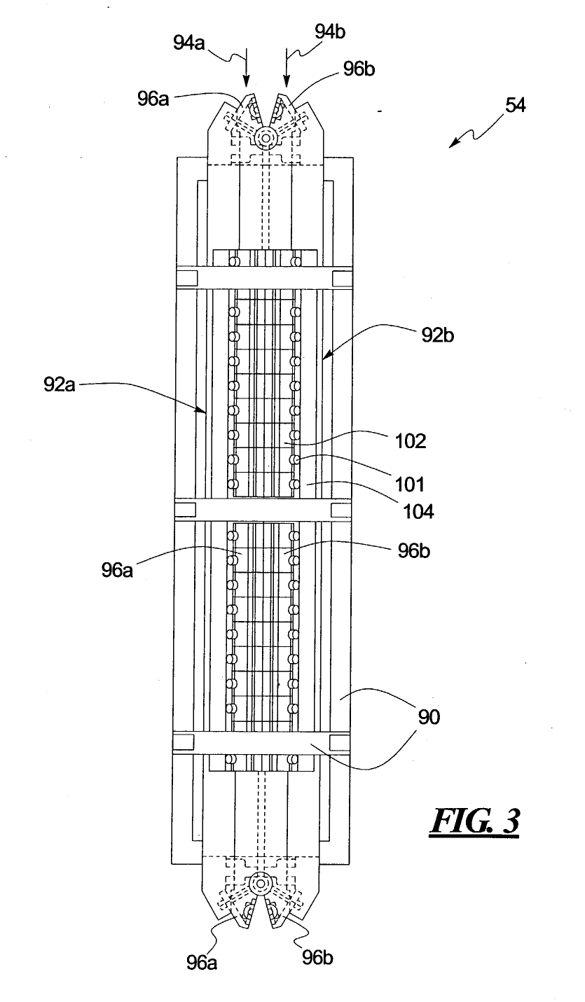

With that in mind, and referring now to FIGS. 3 and 4, one example of the vertically oriented forming section 54 as shown in FIG. 1 is described in accordance with the teachings of the present invention. The forming section 54 generally has a supporting frame structure 90 that is either integrated into the frame structure 58 of the extrusion section 52 or a stand alone frame structure. The structure 90 generally supports a pair of circulating track assemblies 92a and 92b. In this example, the track assemblies are arranged in adjacent, generally parallel planes as a mirror image of one another. Each of the track assemblies 92a and 92b generally defines a continuous or endless path 94a and 94b, respectively, for circulating a plurality of mold segment pair 96a and 96b, respectively, through a part forming region 98 of the tracks. An entrance ‘E’ to the part forming region 98 is placed in alignment with the extrusion die 68 so that the forming region 98 vertically aligns with the molten plastic stream 70. The tracks herein are defined as the two separate moving mold segment paths. The two paths can be driven independently by separate drive systems, or by a single unitary drive chain or the like.

The mold segments 96a, 96b are arranged in pairs that correspondingly travel along the adjacent paths 94a, 94b of the tracks 92a, 92b. When positioned in the part forming region 98, the mold segment pairs 96a, 96b close upon one another to create a part forming cavity (identified and shown in greater detail below) for forming one or more discrete hollow parts or a portion of such a discrete hollow part. As the track assemblies 92a and 92b circulate in the direction of the arrows ‘A’ and ‘B’, respectively, the mold segments 96a and 96b of each pair travel in unison through the part forming region 98 and then travel in unison through a return region 100 on the opposite sides of the respective tracks. In this example, the mold segment pairs 96a and 96b come together and close at the top or upper end of the part forming region 98 and separate and release at the lower end of the region 98. However, the mold segments pairs can travel vertically upward and the extrudate can enter at the bottom of the part forming region, if desired.

The method and components utilized to move the tracks 92a and 92b and to move the mold segments 96a and 96b into and out of engagement with one another as the tracks circulate through each traverse can vary considerably. For example, as shown in FIGS. 3 and 4, rollers 101, cams 102, and guide tracks 103 are known to precisely guide, open, and close the mold segments. The cams 102 attach the roller 101 to the mold blocks 96. The rollers travel along and are guided by three guide tracks 104. The position and orientation of the guide tracks change to drive the mold segments 96a and 96b together and to move them apart as the segments circulate the tracks 92. Also in this example, a motor driven gear or sprocket 106 circulates one or more drive chains or belts 108. The chains or belts 108 carry the mold segments 96. One of many possible means to accomplish mold segment movement and opening and closing is described in, for example, U.S. Pat. Nos. 5,494,430 and 5,645,871 discussed above.

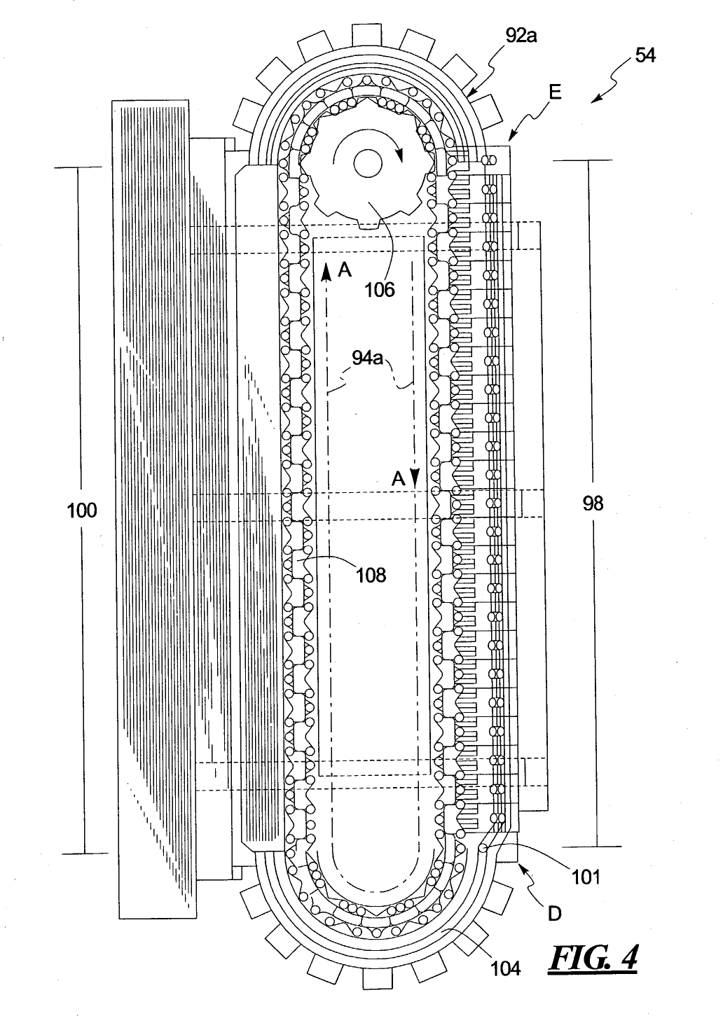

Referring now to FIGS. 5 and 6, an alternative vertically oriented forming section 54 is illustrated. FIGS. 5 and 6 show a side and front view, respectively, of a pair of circulating and opposed track assemblies 110a and 110b. In this example, the track assemblies circulate in opposite directions as shown by arrows ‘A’ and ‘B’, respectively. The tracks 110a and 110b are positioned generally in the same plane wherein one side of each track assembly is positioned adjacent a side of the other track assembly. The adjacent sides together define a part forming region 112.

A plurality of mold segment pairs 114a and 114b are again carried by each track assembly 110a and 110b, respectively. The mold segments 114a and 114b travel in correspondingly opposite directions shown by the arrows ‘A’ and ‘B’. The mold segment pairs 114a and 114b travel through the part forming region 112 in concert with one another and close upon one another to form part forming cavities within the corresponding closed segment pairs. The mold segments 114a and 114b travel through respective return regions 116a and 116b defined on each track assembly 110a and 110b opposite the common part forming region 112. In this example, the mold segment pairs 114 come together and close at the top end or entry E of the part forming region 112 and separate and release at the lower end or exit D of the region 112. In this example, the mold segments pairs 114a and 114b are wide and flat and produce generic thin flat panel parts 72.

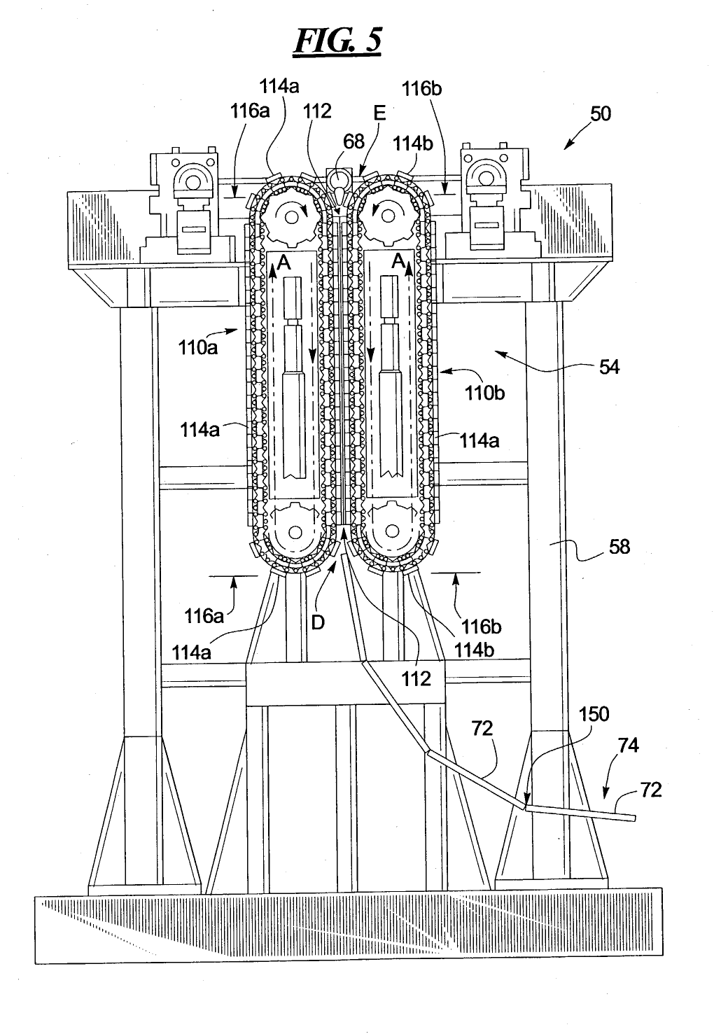

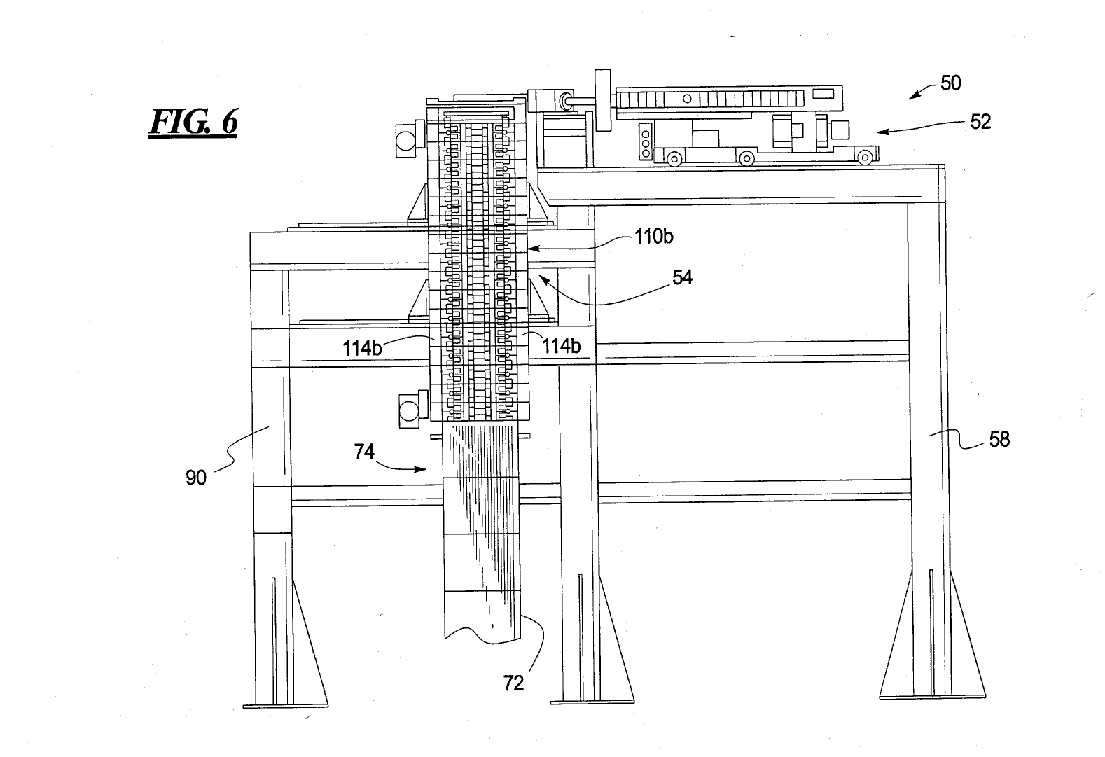

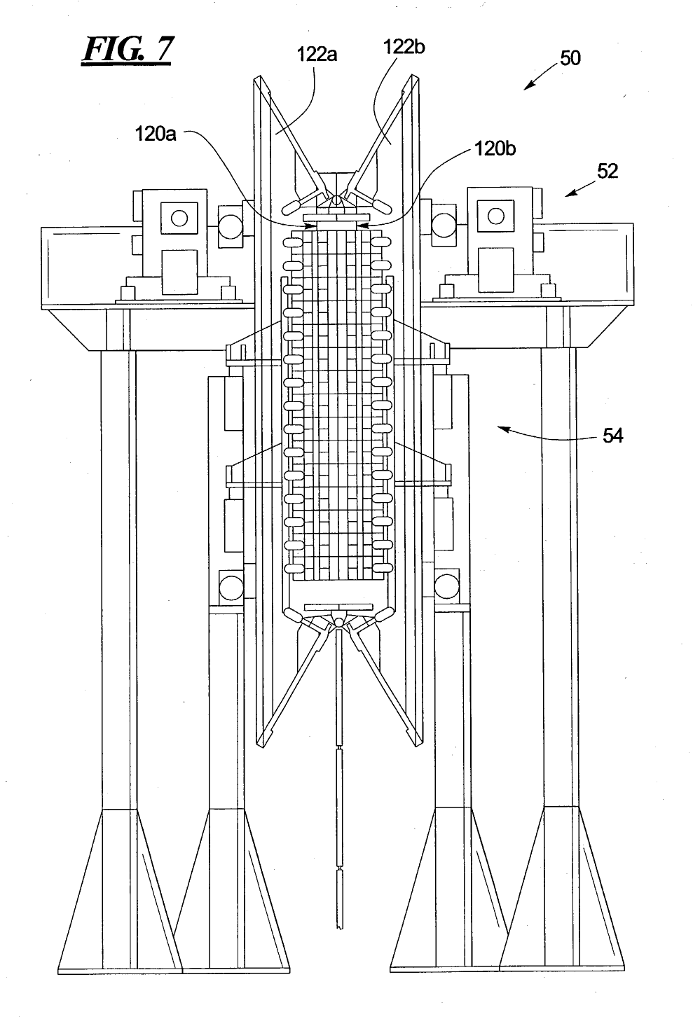

Referring now to FIGS. 7 and 8, another example of a vertically oriented forming section 54 is illustrated. A pair of track assemblies 120a and 120b are arranged in similar side-by-side mirror-image fashion to that illustrated in FIGS. 3 and 4. However, in this example, larger sized mold segment pairs 122a and 122b are mounted to the adjacent circulating track assemblies 120a and 120b, either for producing hollow parts of much larger size, or for forming a plurality of discrete parts within each segment pair. As will be evident to those of ordinary skill in the art, the size and configuration of the individual mold segments 96, 114, or 122 can vary considerably without departing from the spirit and scope of the present invention. Many variations can be utilized in accordance with the teachings of the present invention for producing a variety of different discrete hollow parts.

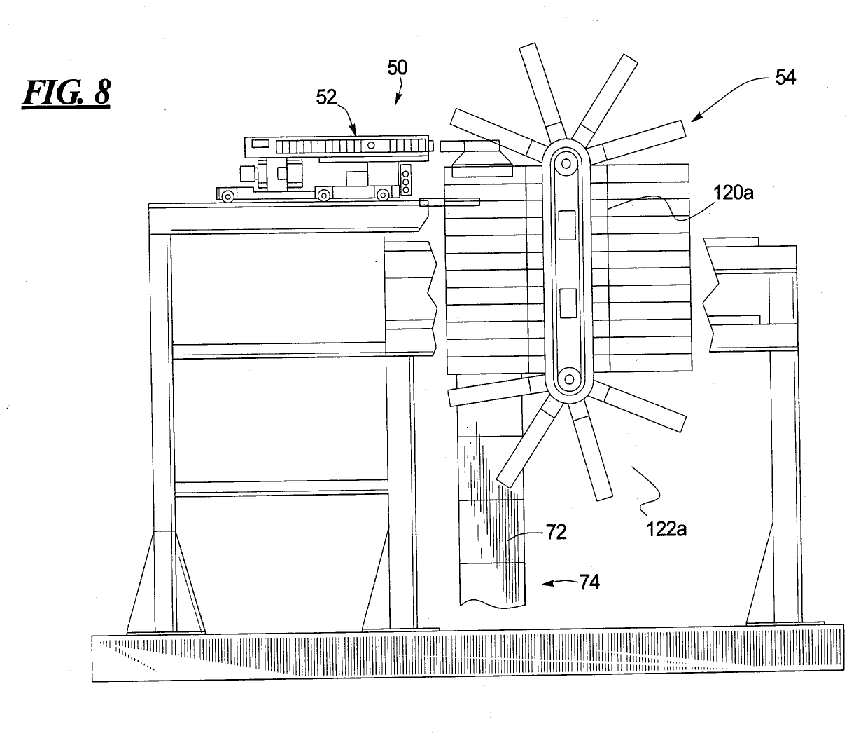

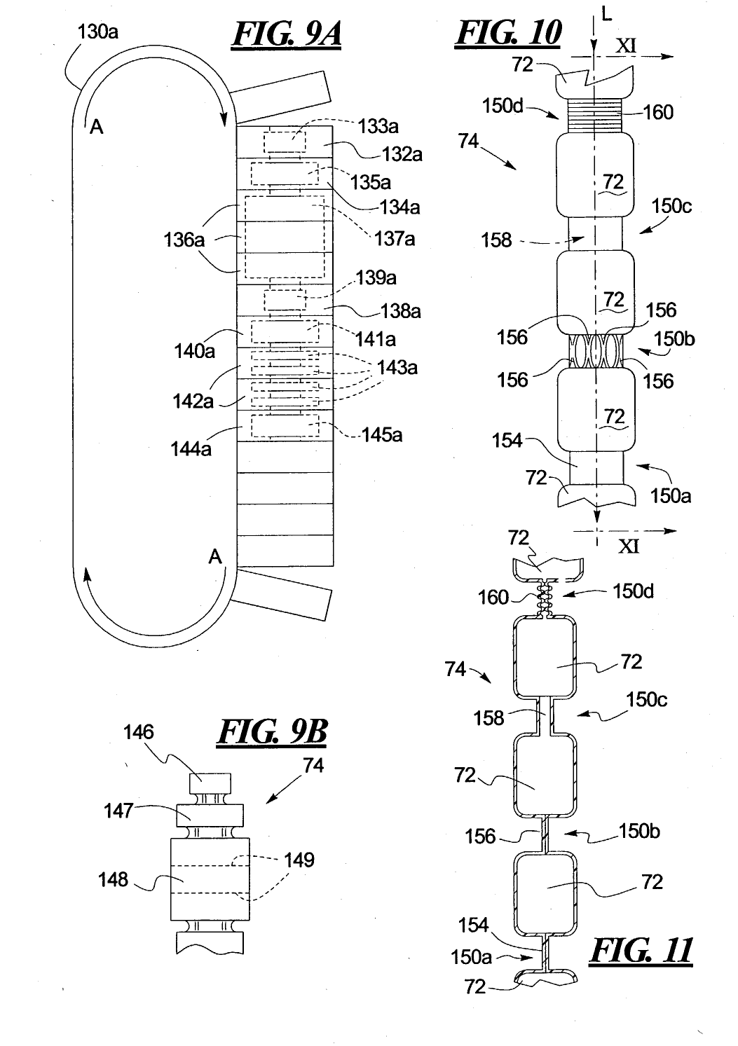

FIG. 9A illustrates one example of a vertically oriented forming section 54 for an apparatus 50. In this example, a plurality of different discrete hollow parts can be produced in a continuous chain 74 utilizing a single forming section setup. A side view of the forming section 54 shows only one track assembly 130a of an adjacent pair. The track assembly 130a circulates in the direction of the arrow ‘A’. A plurality of mold segment pairs adapted to produce parts of different configuration ate carried on the circulating track assemblies in this example. Since only the track assembly 130a of the pair is shown, only one of each pair of mold segments is illustrated. Reference below to an individual mold segment assumes a corresponding mold segment of a pair of segments carried on an adjacent track as described above.

A first mold segment 132a is carried by the track assembly 130a. The mold segment 132a in this example defines a single part forming cavity 133a and produces a first discrete hollow part upon each traverse of the track assembly 130a. A second mold segment 134a is positioned directly adjacent the mold segment 132a and also forms a single part forming cavity 135a. The cavity 135a of the second segment 134a is larger than the cavity 133a of the first segment 132a and produces a part of larger size and/or different shape. Third, fourth, and fifth adjacent mold segments 136a are adjacent the second mold segment 134a and in combination define a single mold cavity 137a for forming one discrete hollow part upon each traverse of the track assembly 130a.

As shown in FIG. 9B, the chain 74 will include a part 146 formed by the cavity 133a, apart 147 formed by the cavity 135a, and a part 148 formed by the multiple cavities 1137a. The part 148 formed by the three segments 136a will have two parting lines or witness lines 149 where the segments meet to define the continuous cavity 137a.

A sixth and a seventh subsequently adjacent mold segment 138a and 140a are positioned adjacent the fifth segment 136a. Each segment 138a and 140a defines a part forming cavity 139a and 141a, respectively, of a different configuration and each segment forms a separate discrete hollow part upon each track traverse.

Eighth and ninth subsequently adjacent mold segments 142a are carried by the track assembly 130a. Each defines a plurality of part forming cavities 143a that are identical to the other, but different from the other, previously described mold segments. In this example, each of the two mold segments 142a and cavities 143a thus produces multiple discrete hollow parts upon each track traverse.

Lastly in this example, the continuous track 130a as shown in FIG. 9A has a tenth next subsequent mold segment 144a with a part forming cavity 145a of yet another configuration for producing another different discrete hollow part upon each track traverse. Thus, the tracks 130 can be configured to have a plurality of different mold segments with different mold cavities to produce a continuous chain of discrete hollow parts of varying length, width, depth, configuration, or the like, as desired.

As shown in FIG. 2, a horizontally oriented forming section can be utilized if desired. In such an apparatus, the part forming regions 98 and 112 in the above examples would, in contrast, be horizontally oriented, but function in the same manner as those region described for each of the vertically oriented forming sections 54 described above.

As illustrated generally in the above FIGS. 1-8, the continuous interconnected chain 74 of discrete hollow parts 72 is released from the closed mold segment pairs as the segments are re-opened in each example of the part forming sections described above. With general reference to the examples shown in FIGS. 1, 3, and 4, and with particular reference to FIGS. 10 and 11, the continuous chain 74 has a longitudinal axis ‘L’ and has a plurality of the discrete hollow parts 72 separated from one another, but interconnected by intervening joints 150.

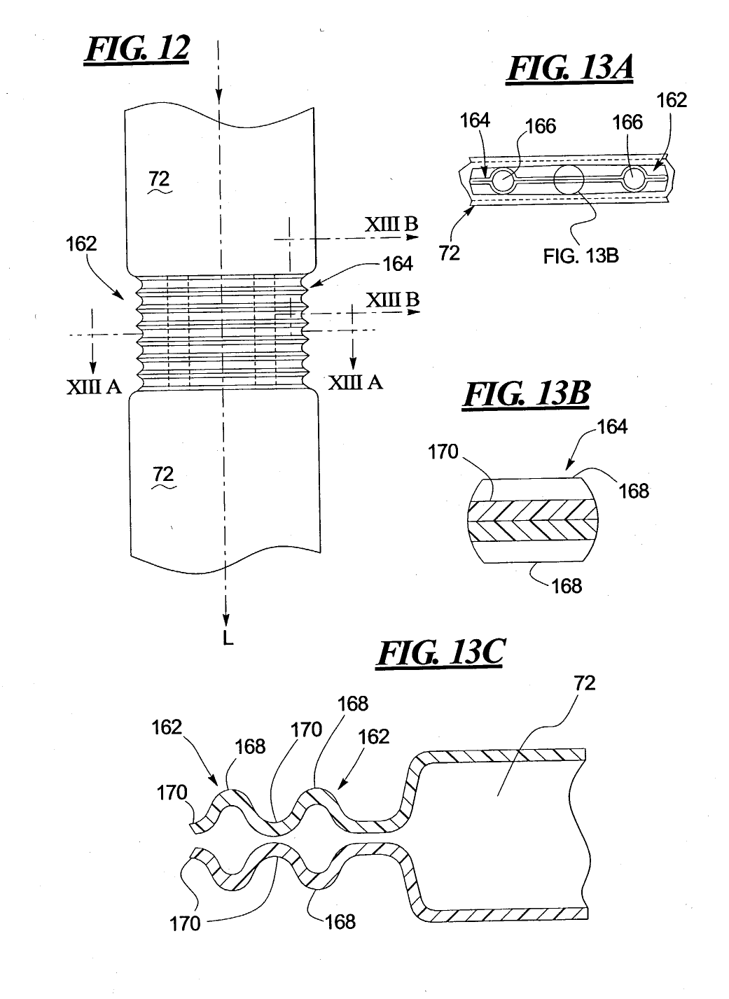

The intervening joints 150 can vary in configuration according to the needs for a particular part fabrication. As shown in FIGS. 10 and 11, a joint 150a can include a single, solid material web 154 extending between and interconnecting adjacent individual parts 72. Alternatively, a joint 150b can include a series of laterally spaced apart material webs 156 extending between and interconnecting adjacent parts 72. Alternatively, and for reasons discussed in further detail below, it may be necessary to fabricate a joint 150c with a hollow interior 158 between discrete hollow parts 72, or with a plurality of air passages (see FIGS. 12 and 13A-C) extending between adjacent discrete hollow parts. Air can pass freely between interiors of the adjacent parts 72 through the passageway or hollow joint interior 158 in the joint 150c, if desired.

As in the example shown in FIG. 1, it may be desirable for a joint 150 to be flexible relative to at least one axis to permit the continuous part chain 74 to bend or curve from the vertical molding orientation to a horizontal downstream travel orientation. The three different types of joints 150a, 150b, and 150c described above with reference to FIGS. 10 and 11 may be somewhat flexible, depending upon material type and thickness, and may provide satisfactory flexibility for some applications. FIGS. 10 and 11 illustrate one example of a substantially flexible joint 150d disposed between the top two adjacent parts 72. In this example, the joint 150d is formed having a plurality of bellows or convolutions 160 spaced apart longitudinally and extending circumferentially around the joint of the part chain 74. The plurality of convolutions 160 permit relatively easy flexure of the joint 150d between adjacent discrete parts 72 at least in one longitudinal direction relative to the axis ‘L’ of the continuous part chain 74.

Referring now to FIGS. 12 and 13A-13C, it may be desirable to have a substantially flexible joint that also has one or more air passages extending between the adjacent part interiors. Such an alternative flexible joint 162 is shown and has a plurality of convolutions 164 and one or more air passages 166 providing air communication between the adjacent hollow discrete parts 72. In this example, each of the convolutions 164 has a plurality of peaks 168 and troughs 170. The opposed troughs 170 can be joined to one another or tacked off laterally across the joint 162 and between the air passages 166. Alternatively, the opposed troughs 170 can be separated by a small gap between opposed troughs on opposite sides of the joint 162 as shown in FIG. 13C. The convolutions 164 in this example permit the part chain to flex in one direction relative to the longitudinal axis ‘L’ as shown in FIG. 1. In this example, the discrete hollow parts 72 are at least partially open-ended by inclusion of the passages 166. If the troughs are tacked off, the only openings between parts are the passages 166. If not tacked off, as shown in FIG. 13C, the entire joint 162 defines open ends of adjacent parts 72.

FIG. 13D illustrates another example of a joint construction. The joint is substantially identical to the convoluted joint 160 shown in FIG. 13C, except that the joint surfaces between the first convolution 162 and the part 72 have been tacked off entirely across the joint. If tacked off in this manner adjacent each part, the joint in this example is a closed end part in and of itself. Thus, the joint need not have the passages 166 because no air would be pass through the joint nor between parts on opposite sides of the joint. However, as is discussed below, the air within the joint shown in FIG. 13D would most likely require replenishment, similar to discrete hollow parts 72.

As noted previously, the apparatus and methods according to the teachings of the present invention permit fabrication of both open-ended and closed-end discrete hollow parts. Referring back to FIGS. 10 and 11, the convolutions 160 of the joint 150d form a closed-end for each adjacent end of the interconnected hollow parts 72. The hollow joint 158 produces an open end for each adjacent end of the interconnected hollow parts 72. The single or multiple web joints 150a and 150c, respectively, each form closed-end hollow parts adjacent these joints. Methods and structures are described in greater detail below which permit fabrication of either open or closed-end discrete hollow parts 72 while maintaining a pocket of air within the interior of the hollow parts.

Referring back to FIGS. 1 and 2, the cooling section 56 in each of these examples is a separate section located downstream of the part forming section. The continuous interconnected chain 74 of discrete hollow parts 72 is delivered to the discrete cooling section 56 for cooling the entire chain of parts. The stand alone cooling section 56 can take on one of many different possible forms. In one example illustrated in FIG. 14, the cooling section 56 can include a water bath 180 through which the part chain 74 is passed and immersed. Alternatively, as shown in FIG. 15, the cooling section 56 can include a water spray or shower 182 produced by a plurality of nozzles 184. In each of these examples, the cooling section 56 can have a housing 186 defining a cooling chamber 188 supported by a separate frame 190. The cooling chamber 188 can house the water bath 180 and/or the plurality of nozzles 184, as desired.

As shown in FIG. 16, instead of water, moving air ‘F’ can be utilized to cool the continuous chain 74 of the discrete hollow parts 72 in a downstream cooling section 56. In this example, again, a housing 186 defines a cooling chamber 188 and can be supported by a frame 190. One or more fans 192 can be utilized to direct air into the cooling chamber 188 and across the chain 74 of parts 72. The flow of air ‘F’ can be directed in essentially any direction over the part chain 74 and through the housing 186. In one example, the housing 186 can be perforated permitting air to freely enter and exit the housing as desired.

As will be evident to those having ordinary skill in the art, a flow of air can alternatively be passed directly over the part chain 74 without use of a housing 186 in order to cool the parts 72. Many different configurations and constructions of the various cooling sections 56 described herein, as well as other cooling section constructions, can be utilized and yet fall within the scope of the present invention. For example, the parts can be cooled after being formed, but prior to exiting the forming section 54 as is described in greater detail below. Air can be passed through the interiors of the discrete hollow parts in the chain, before or after separation from the chain and before or after exiting the forming section 54.

After the parts 72 in the continuous chain 74 have been sufficiently cooled, they can be separated from the chain as discrete hollow parts. Each part can be appropriately trimmed to remove excess parting line or flashing material. Methods and machines are commonly known for separating and trimming plastic molded parts and will not be described in detail herein. Additionally, parts having a number of components can be made in the same chain. The separate components can be cut and/or trimmed appropriately and then assembled. In one example, a plastic trash container and a lid for the container can be fabricated as a single discrete hollow part, with closed ends, in an interconnected chain of such trash container parts. During the trimming operation, each lid and container assembly can be separated from the other assemblies and each lid can be separated from its respective container. Each part can then be further trimmed or finished as necessary. Many other examples are certainly possible that will fall within the scope and spirit of the present invention.

Details of the methods and mold segments are now described in accordance with the teachings of the present invention. As shown in FIGS. 1 and 2, the extrusion die 68 extrudes a stream of molten plastic to the entrance ‘E’ of the forming section 54 of the apparatus 50. The die configuration can vary considerably according to the needs of a particular part formation process. As briefly noted above, the extrusion die 68 in one example can extrude a single stream 70 of molten plastic. Several alternative die constructions are described herein.

Referring to FIG. 17, one example of the extrusion die 68 is shown in greater detail. The die has a flow passage 200 extending through a body 202 of the die 68. Molten plastic 70 is delivered to the passage from the extrusion section 52, flows in the direction of the arrow ‘P’ through the passage 200, and exits the passage at a die head 204. The die head 204 can be configured to produce desired characteristics in the molten stream 70 of plastic as desired. The single stream 70 of molten plastic can be utilized with a variety of different apparatus and mold segment configurations and arrangements, such as those shown in FIGS. 1-9B.

To illustrate, the continuous stream of molten plastic 70 can be delivered in one example to a mold segment pair, represented by the segment 132a shown in FIGS. 9 and 18. The segment 132a, along with the other segment of the pair (not shown), can define a single part forming cavity 133a. The single segment pair and the single molten plastic stream 70, in this example, produce one discrete hollow part. Alternatively, as shown in FIGS. 9 and 19, a mold segment 142a can define a plurality of longitudinally aligned part forming cavities 143a. The single stream of molten plastic 70 and the single segments pair, in this example, produce a plurality of separate discrete hollow parts. In each of the examples shown in FIGS. 18 and 19, the part forming cavities 133a and 143a also have a region or regions 214 that form one or more of the joints 150 to interconnect adjacent ones of the discrete hollow parts 72.

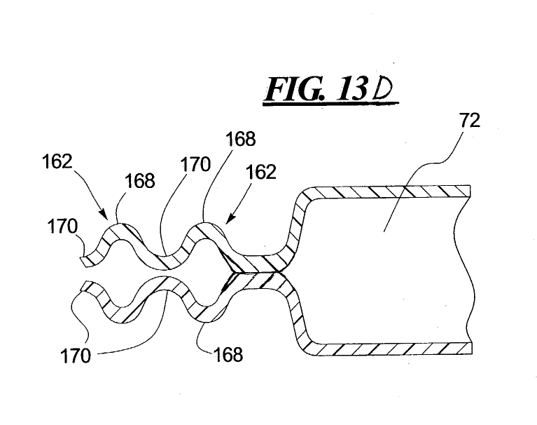

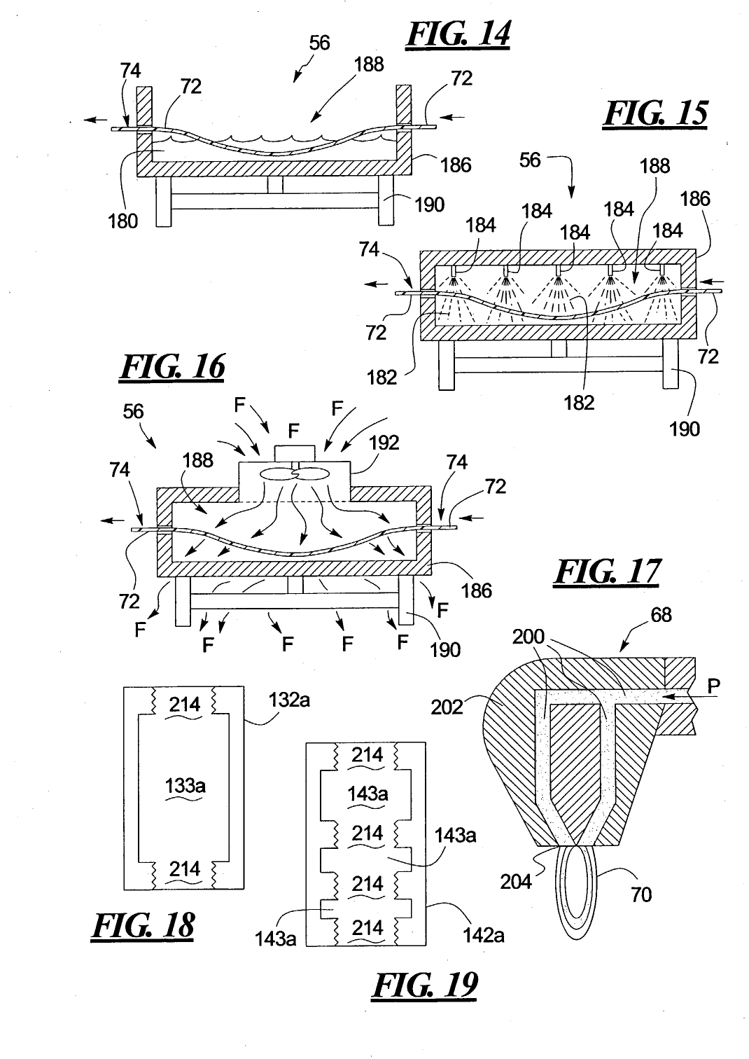

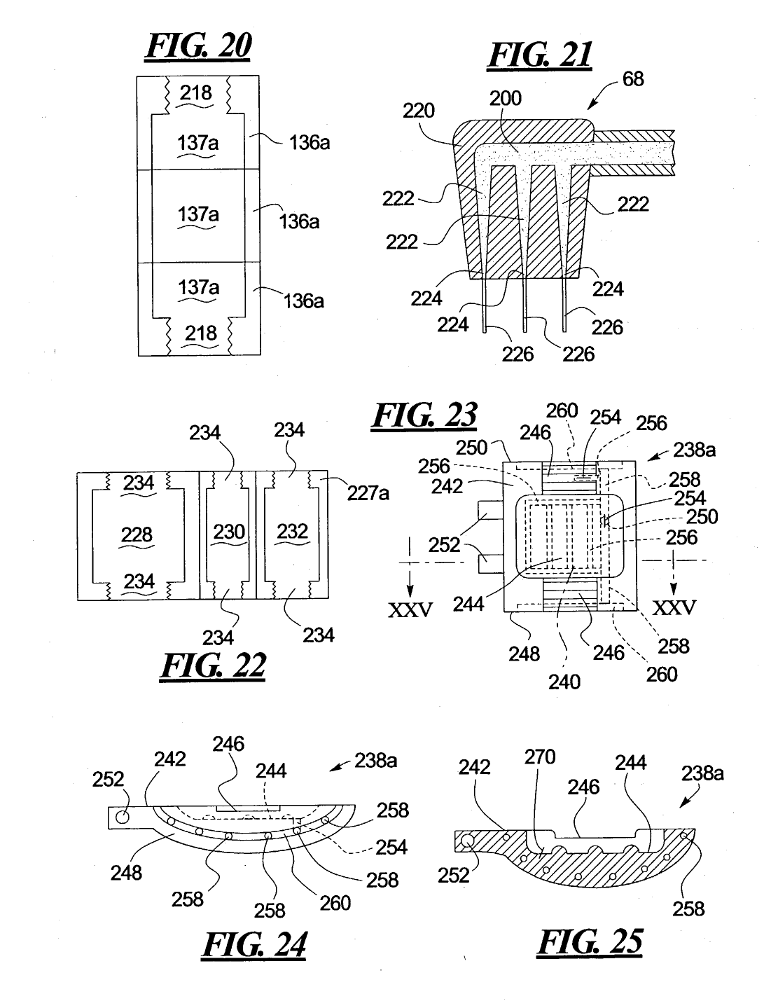

Similarly, as shown in FIGS. 9 and 20, a plurality of longitudinally adjacent mold segments 136a can, in combination, define a single part forming cavity 137a. Each of the discrete segments 136a forms only a portion of the cavity 137a and only the mold segments 136a that terminate the cavity 137a define a joint forming region 218 of the cavity.

In another alternative embodiment, the die 68, as shown in FIG. 21, can include a body 220 with multiple flow passages 222 that terminate at corresponding separate die exits or heads 224 arranged spaced apart from one another. The multiple exits form a plurality of adjacent molten plastic streams 226 exiting the die 68. The body can include one inlet passage that splits into multiple outlet passages 222, as shown in FIG. 21. In the example of FIG. 21, the plastic stream 226 flowing from each die head 224 will be the same. However, it may be desirable to have two or more streams of different materials. In one alternative example, two or more separate inlet passages can deliver two different plastic materials to the multiple die heads 224, similar to the inlet passages shown in FIG. 31 described below. Two or more plastic streams 226 of different material compositions can thus be formed, if desired.

As shown in FIG. 22, a pair of mold segments represented by the single segment 227a can define a plurality of laterally spaced and discrete part forming cavities 228, 230, and 232. Each molten plastic stream 226 shown in FIG. 21 will align with an appropriate one of the cavities 228, 230, and 232. Each cavity will a produce a separate discrete hollow part, and thus, the segment 227a will produce multiple parts upon each traverse of the track. Again, each of the cavities 228, 230, and 232 can include a joint forming region 234 with an adjacent cavity of an adjacent segment. In accord with this example, multiple side-by-side continuous chains 74 of discrete hollow parts 72 can be produced.

As will be evident to those having ordinary skill in the art, a combination of the mold segments examples shown in FIG. 20 (multiple segments form one elongate cavity) and FIG. 22 (each segment forms multiple adjacent cavities) can also be utilized. As will be evident to those having ordinary skill in the art, many other configurations and arrangements are possible in accordance with the teachings of the present invention.

Once molten plastic is within a part forming cavity of a closed mold segment pair near the entrance ‘E’ of the part forming region such as the region 78 shown in FIGS. 3 and 4, a pressure differential is created within the cavity to conform the molten plastic to the contour of the part forming cavity. In one example, a vacuum can be applied to the cavity surfaces to draw the molten plastic against the surfaces. Alternatively, a positive air pressure can be applied to the interior of the molten plastic stream to “blow” the molten plastic against the cavity surfaces. A combination of vacuum and positive air pressure can also be utilized.

Referring now to FIGS. 23 and 24, an example of a system for applying a vacuum is illustrated. Such arrangement is similar to those described in U.S. Pat. Nos. 5,059,109, 5,494,430, and 5,645,871 as described for use in forming continuous corrugated pipe. In the present example, a mold segment such as a segment 238a shown in FIGS. 3 and 4 has a part forming cavity 240 fabricated in what is termed herein as a front face 242. The cavity 240 has a part forming region 244 and joint forming regions 246 positioned adjacent a pair of opposed end faces 248 and 250. In this example, the end face 248 is a leading end face and the end face 250 is a trailing end face. The leading end face 248 abuts against an adjoining and preceding segment relative to the direction of motion of the track assembly when the apparatus is operating. The trailing end face 250 abuts against an adjoining and subsequent segment. The front face 242 abuts against the corresponding front face of the opposite mold segment pair traveling on the other circulating track assembly. The segment 238a has a carriage mount 252 on one side of the segment for pivotally attaching the segment to a carriage (not shown) that is carried on the circulating track, such as track 92a as shown in FIGS. 3 and 4.

In this example, the part forming region 244 of the cavity 240 has various surface contours for forming one-half of a discrete hollow part exterior surface. The surface contour of the part forming region 244 can include virtually any contour to form particular surface features in the part, as desired.

To apply a vacuum to the part forming cavity 240, a plurality of openings 254 are strategically provided throughout the surface of the cavity 240 in both the forming regions 244 and 246. Only a pair of the openings 254 are shown in FIG. 23 and only one is shown in FIG. 24. However, any number of the openings 254 can be utilized to provide uniform vacuum within the cavity 240 to conform the molten plastic material to the cavity contour. Further, the openings can be holes of any desired configuration, elongate slits, or the like. Further, a porous material, such as porous aluminum can be utilized with or without discrete passages and ports. A vacuum can be drawn directly through the porous material to draw the plastic material toward the mold cavity surfaces.

Vacuum can be delivered to the openings 254 through intermediate ports 256 that are in communication with the openings. One or more primary ports 258 extend between the end faces 248 and 250 of each segment and communicate between the intermediate ports 256 and circumferential grooves 260 formed within and extending around each the closed end faces 248 and 250 of each segment pair 238a and 238b. The grooves 260 mate with corresponding grooves on adjacent end faces of adjacent segments and define continuous air paths around the circumference of the mated and abutting segments. A vacuum is applied to the grooves 260 when the segment pairs are in the forming region 98, and thus vacuum is further applied at each opening 254 via the primary and secondary ports. Methods and systems for creating the vacuum and supplying same to the part forming regions and to the individual mold segments can vary according to the particular machine and mold cavity geometries.

The applied vacuum through the multiple openings 254 conforms the molten plastic material to the contour of the cavity 240. Air within the molten plastic part, when the part is being formed, is heated by the high temperature or hot plastic material and mold segment material. Once the continuous string 74 of the discrete parts 72 is released from the closed mold segment pairs at the discharge ‘D’ of a forming region 98, the molten plastic will begin to cool. Thus, air within the discrete hollow parts will also begin to cool. Without replenishing air to the interior of the plastic parts, the part walls could collapse or at least partially deform collapse because the cooler air is less dense and takes up less volume. The air within the hollow parts can be replenished in a number of ways.

One alternative method is to manually pierce each discrete hollow part upon its release from the re-opened mold segments at the discharge ‘D’. Manual piercing can be done by puncturing a wall of each molded part, or by puncturing or forming a opening at the joint 150 between each adjacent part 72. Once a puncture or opening is formed, air can enter the interior of the hollow parts to replenish the air therein and equalize pressure.

A more efficient alternative is to automatically pierce each part as it is formed. In one example illustrated in FIG. 25, a projection or puncturing device, such as a solid needle 270, can extend from a surface of the cavity 240 into the interior space of the cavity. The needle 270 will extend inward from the cavity surface a distance that is thicker than the intended wall thickness of a discrete hollow part when formed. The needle 270 will therefore create a puncture or opening through a wall of the molded part permitting air to enter the part to replenish air therein. Air replenishing equalizes pressure between the interior and exterior of the part to prevent the walls from collapsing upon one another. When the continuous string 74 of discrete hollow parts 72 is discharged, the needle 270 will release from the puncture or opening, leaving a small hole that permits air to enter the part interior. The needle 270 or other such puncturing device can be mounted or installed post-completion of the cavity surface 240 or can be cast, machined, or otherwise formed integrally with the mold segment 238a or other such segment.

As another example, pure vacuum can be used to puncture a part as needed. A male boss in the part could be fabricated by providing a female depression in the mold. A vacuum opening or orifice in the female depression could apply a strong enough vacuum at the male protrusion location to physically draw the plastic material into the orifice or opening and create a rupture in the plastic thereat. The vacuum at the orifice or opening can be controlled as needed to apply the required amount of vacuum at the desired time during part formation.

FIG. 26 illustrates another alternative for replenishing air within the interior of the discrete hollow parts. This example is substantially similar to that shown in FIG. 25. However, the puncturing device, or solid needle, shown therein is replaced in this example with a hollow needle 272 with an air passageway 274 extending therethrough. The passageway 274 communicates with, in this example, one of the primary ports 258 of the mold segment body. In this example, the hollow needle is part of a valve assembly insert 276. The passageway 274 communicates with a chamber 278 in the assembly. The chamber 278 communicates with a port 280 that is in communication with a primary port 258 in this example. Thus, air can pass between the needle passageway 274 and the primary port 258. Alternatively, the valve assembly and the hollow needle could also simply vent to atmosphere, if desired, to replenish the air in the molded parts. In yet another example, air need not be the replenishing gas. There may be a need for utilizing a different gas, such as nitrogen, carbon dioxide, or the like, for part replenishment.

A positive air flow can be delivered through the selected primary port 258 and needle passageway 274 to the interior of the part forming cavity. In this example, the hollow needle 270 can be utilized to apply a positive air pressure to the interior of the discrete hollow parts as they are formed. In one example, the positive air pressure can supplement the vacuum applied to the exterior of the conformed parts by the plurality of openings 254 shown in FIGS. 23 and 24. Once the conformed part is discharged from the re-opened segments 238a and 238b, the hollow needle 272 will also create a puncture in a wall of the discrete molded part. The puncture again provides a means for air to pass freely between the interior and exterior of the part to replenish the air within.

As noted above, parts 72 can be at least partly cooled while still in a closed mold segment pair. In one example, cooling air can be delivered to the part interiors via the hollow needles 274, if desired, to cool the parts prior to release from the mold segments, as well as to positively replenish the air within the parts.

Multiple needles can be provided for a single mold segment pair, if needed or desired. Again, the methods and systems to deliver air to the mold segments and to the needles can vary according to a particular machine and mold cavity geometries.

A positive air pressure can also be delivered to the interior of the molten plastic stream. In this way, a positive air pressure can be utilized to blow or force molten plastic material against the surfaces of the mold cavities to form parts. This positive air pressure can be utilized in lieu of the above described vacuum, or as an enhancement for the vacuum. The positive air pressure can be delivered to the plastic stream within the die, after exiting the die, or after the plastic is received in the closed mold segments.

As discussed above, the downstream cooling section 56 can be eliminated and a means of cooling the string of parts within the forming region (such as the region 98) of the apparatus can be utilized. In one example, a positive air flow at ambient temperature or another desired temperature can be passed over the closed mold segment pairs in the forming region, such as the region 98 as shown in FIGS. 3 and 4, to dissipate heat from the mold segments. Air can also be moved across the part string 74 at the discharge point ‘D’. For this means, the air temperature, the air velocity, and the location at which the air flow is applied can be controlled to adequately cool the discrete hollow parts prior to or at the discharge point ‘D’. Also, the exterior surface of the segments 96a and 96b can be formed having a plurality of fins to increase surface area in order to more efficiently dissipate heat.

In another alternative, a plurality of cooling passages can be provided through the individual mold segments, as is known in the art. A cooling fluid such as water can be circulated through the passages as the mold segments pass through the forming region 98 in order to dissipate heat from the mold segments and the discrete molded parts 72 within the cavities 240. Compressed and/or cooled air can alternatively be circulated through passages in the segments as another alternative.

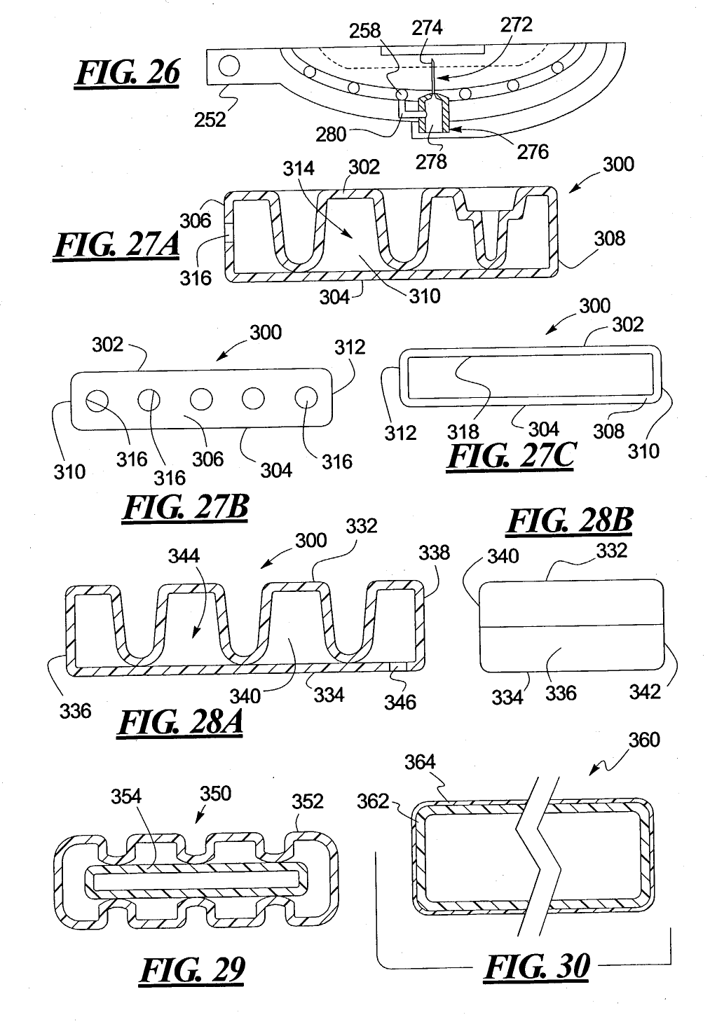

The apparatuses and methods described above can be utilized to fabricate discrete hollow parts in innumerable forms and constructions. FIGS. 27A-C illustrate one example of a discrete hollow part having open end walls and that can be produced by the continuous molding process according to the teachings of the present invention. As shown in FIG. 27A, a cross section of an exemplary discrete hollow part 300 has a complex contoured exterior surface including an upper or top wall 302, a lower or bottom wall 304, a first end wall 306, and an opposite end wall 308. The discrete hollow part 300 also has a first side wall 310, an opposite side wall 312, and a hollow interior 314 defined within the top and bottom walls, end walls, and side walls.

As shown in FIG. 27A, the hollow interior 314 can include a number of separate chambers, pockets, and the like, depending upon the particular wall contours. In this example, the top wall surface is complex and includes a number of depressions and recessed areas. The bottom wall is essentially flat as are the end walls and side walls. As shown in FIG. 27A, the top and bottom walls can be tacked off, if desired, at various points to add strength and rigidity to the part 300.

As shown in FIG. 27B, one exemplary open end wall 306 has a plurality of openings 316 that can be formed utilizing a flexible joint 162 construction as illustrated in FIGS. 12 and 13A-C including the longitudinal passages. As shown in FIG. 27C, another exemplary opposite end wall 308 can include a single opening 318 in the end wall 308. Such an opening can be formed using the hollow joint 158 shown in FIGS. 10 and 11. The configuration of the openings 316 and/or 318 in the end walls of the open ended hollow part 300 can vary considerably and can be determined by the particular contour of the mold segments, part forming cavities, and joint regions of these cavities. The open ends can be formed and contoured for use in conjunction with other parts and components, connectors, fasteners, couplers, or other devices, depending upon the particular end use for the discrete hollow part 300. The possible variations and permutations are many.

Referring now to FIGS. 28A and 28B, a discrete hollow part 330 is illustrated having closed end walls and side walls and a hollow interior. The hollow part 330 in this example has a contoured top wall 332, a bottom flat wall 334, first and second closed end walls 336 and 338, and first and second closed side walls 340 and 342. The hollow part 330 also has a hollow interior 344 which again can be compartmentalized depending upon the particular surface contours and tack off points, if any, of the various walls.

In this example, a puncture opening 346 is also shown in the bottom wall 334. The puncture opening can be formed by the previously described method utilizing the solid needle 270 or hollow needle 272. For closed end panels formed by the continuous molding process disclosed herein, it is preferable to provide the puncture opening 346 in each of the parts to prevent the walls from collapsing upon one another as the part cools. To form the closed end part 330, the joints 154, 156, and 160 as shown in FIGS. 10 and 11, as well as other interconnecting joint configurations, can be used between parts in a continuous string. Excess parts of the joints can be trimmed from the finished part 330, if not needed.

In another example according to the teachings of the present invention, a multilayered discrete hollow part can be fabricated. A multilayered discrete hollow part 350 is shown in cross section in FIG. 29. The part 350 has an exterior component 352 and an interior component 354, each independently comprising a discrete hollow part in this example, similar in construction to the parts 300 or 330 as described above. Such a part can be fabricated with the internal and external component parts substantially simultaneously formed.

FIG. 30 illustrates another example of a multi-layered part 360 formed in accordance with the teachings of the present invention. The wall of the part 360 is shown in cross section. In this example, the wall of the part 360 has two separate layers including an inner layer 362 and an outer layer 364. The inner, non-visible layer 362 can be fabricated from a less expensive material, such as one having high strength but no pigment and rough texture. The outer visible layer 364 can be molded in conjunction with the inner layer 362 as a skin having a desired pigment, texture, and/or other desired properties. Thus, a part 360 can have a desired appearance and feel without forming the entire part from a more expensive material. Many variations are permissible. For example, the inner layer 364 can be made of a recycled material whereas the outer layer 362 can be made from a virgin material with desired properties. Parts having more that two layers can also be fabricated.

FIG. 31 illustrates a dual exit die 380 that can be adapted to form multilayered parts, such as those shown in FIGS. 29 and 30, for example. The die 380 has a body 382 defining a pair of flow passages 384 and 386. The passage 386 is provided concentrically interior to the passage 384, at least near a dual die exit 389. Thus, a dual molten plastic stream or extrudate 388 exits the die. The stream 388 has an inner component 390 surrounded by and concentric with an outer component 392. The two stream components 390 and 392 can be of the same or of different molten materials.

In general, the die is aligned with a mold having dual formed cavities with two cavity inlets, one aligned with the inner component 390 of the stream 388 and the other aligned with the outer component 392 of the stream 388. In this example, the external part component 352 of the discrete hollow part 350 can be formed from one type of plastic material and the internal component 354 can be formed from a different plastic material. For example, the internal component can be formed from a harder, more substantial material to provide structural rigidity for a particular type of part 350. The external component 352 can be provided from a different, softer, or lower durometer material to form a desired feel and/or appearance. The internal component can also be a solid filler material, such as foam, completely filling the interior of the external part component 352.

A discrete hollow part fabricated in accordance with the teachings of the present invention may require an in set portion or an undercut. One or more of the mold segments can be provided utilizing slides, movable inserts, sliding pins, or the like to produce such a blow molded part. A mold cavity can be provided using slides or movable mold segment inserts to form undercuts and complex formations in the molded parts. The slides or other structures can be actuated mechanically, pneumatically, or the like as the mold segments enter the part forming region of the apparatus and retracted just prior to when the segments are leaving the part forming section. In this way, an inset or undercut can be formed in the part, and yet the molds can be separated to release the part from the mold segments.

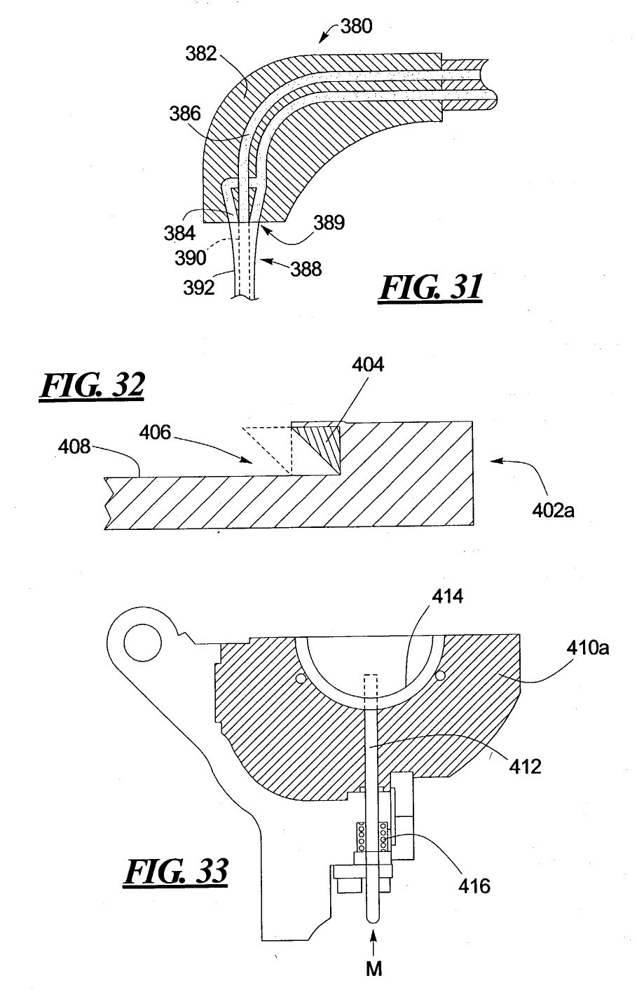

One example is generically illustrated in FIG. 32, which shows a cross section of a portion of a mold segment 402a with a slide 404 for forming an undercut. The segment 402a has an undercut region 406 in the cavity 408. To form the undercut region, the slide 404 can be extended during the molding process as shown in phantom. To release the part, the slide can be retracted providing-clearance to remove the part from the cavity 408.

FIG. 33 illustrates an example of a mold segment 410a having a slideable pin 412 that can be extended (shown in phantom) into the cavity 414 by application of a mechanical, pneumatic, or other force during the molding process. The pin 412 can be retracted from the cavity to permit the part to be released from the cavity 414. In this example, the force applied to extend the pin 412 must be sufficient to overcome a biasing force created by a compression spring 416. Upon release of the extension force, the spring biases the pin to its retracted position. In this example, the pin 412 can be utilized to create an inset region in a discrete hollow part.

In the example of FIG. 32, the slide or pin 412 slides generally perpendicular to the direction of movement of the segment. However, slides, pins, and other movable mold parts can be adapted to move generally parallel to or at some other angle relative to the direction of movement of the mold segments.

Although certain part forming methods and apparatuses have been disclosed and described herein in accordance with the teachings of the present invention, the scope of coverage of this patent is not limited thereto. On the contrary, this patent covers all embodiments of the teachings of the invention fairly falling within the scope of the appended claims, either literally or under the doctrine of equivalents.

What is claimed is:

1. An apparatus for forming discrete hollow parts, the apparatus comprising:
an extruder;
a plurality of mold segment pairs that are arranged to close on at least one stream of molten plastic extruded by the extruder, each pair defining at least a portion of a part forming cavity when closed;
an applied pressure differential in the closed mold segment pairs that forms the molten plastic into discrete hollow parts;
an air replenisher to replenish air in the discrete hollow parts; and
a part cooling means.

2. An apparatus according to claim 1, wherein the extruder is arranged to extrude the at least one stream of molten plastic in a vertically downward orientation.

3. An apparatus according to claim 1, wherein the plurality of mold segment pairs are carried by a pair of continuous tracks each circulated through a plurality of traverses, wherein each track carries one mold segment of each of the plurality of mold segment pairs, and wherein the plurality of mold segment pairs are opened and closed during each traverse of the pair of continuous tracks.

4. An apparatus according to claim 3, wherein the pair of continuous tracks lie generally in adjacent spaced apart parallel planes.

5. An apparatus according to claim 3, wherein the pair of continuous tracks lie generally in the same plane and circulate in opposite directions.

6. An apparatus according to claim 1, further comprising:
multiple streams of molten plastic.

7. An apparatus according to claim 6, wherein the multiple streams of molten plastic are extruded adjacent one another.

8. An apparatus according to claim 6, wherein the multiple streams of molten plastic are extruded concentric to one another.

9. An apparatus according to claim 6, wherein the multiple streams of molten plastic include at least two streams, each stream being of a different molten plastic material.

10. An apparatus according to claim 1, wherein the pressure differential further comprises:
a negative air pressure applied to mold cavity surfaces within each of the plurality of mold segment pairs when closed.

11. An apparatus according to claim 1, wherein the pressure differential further comprises:
a positive air pressure applied interior to the at least one stream of molten plastic within the plurality of mold segment pairs when closed.

12. An apparatus according to claim 11, wherein the air replenisher is the pressure differential and wherein a hollow needle is provided in at least one segment of each of the plurality of mold segment pairs that pierces the molten plastic when each of the plurality of mold segment pairs is closed to apply the pressure differential.

13. An apparatus according to claim 1, wherein the air replenisher further comprises:
a puncturing device provided in at least one segment of each of the plurality of mold segment pairs that pierces or ruptures the molten plastic when each of the plurality of mold segment pairs is closed.

14. An apparatus according to claim 1, wherein the cooling means comprises:
cooled and closed mold segments to cool the discrete hollow parts as they are being formed.

15. An apparatus according to claim 1, wherein the cooling means comprises:
a cooling bath located downstream of a part exit from the closed mold segments, wherein the discrete hollow parts are passed through the cooling bath after being formed.

16. An apparatus according to claim 1, wherein the cooling means comprises:
a positive air flow passed over the mold segments as the discrete hollow parts are being formed.

17. An apparatus according to claim 1, wherein the cooling means comprises:
a positive air flow passed over the discrete hollow parts after the discrete hollow parts exit from the close cold segments.

18. An apparatus according to claim 1, wherein one or more mold segment pairs of the plurality of mold segment pairs each define an entire mold cavity that produces a single discrete hollow part each time the one or more mold segment pairs are closed.

19. An apparatus according to claim 1, wherein at least two adjacent mold segment pairs of the plurality of mold segment pairs together define an entire mold cavity that produces a single discrete hollow part each time the at least two adjacent mold segment pairs are closed.

20. An apparatus according to claim 1, wherein one or more mold segment pairs of the plurality of mold segment pairs each define a plurality of separate mold cavities to produce a plurality of discrete hollow parts each time the one or more mold segment pairs are closed.

21. A method of continuously forming discrete hollow parts, the method comprising the steps of:
extruding a continuous stream of molten plastic;
arranging a plurality of mold segments such that one or more segments periodically close on the stream of molten plastic and form discrete mold cavities;
creating a pressure differential within the discrete mold cavities to shape the molten plastic accordingly;
replenishing an interior of the discrete hollow parts formed in the discrete mold cavities with a gas; and
cooling the discrete hollow parts.

22. A method according to claim 21, wherein the step of arranging further comprises:
coupling a plurality of mold segment pairs to an adjacent pair of circuitous tracks, one segment of each mold segment pair to each of the circuitous tracks; and
circulating the circuitous tracks through multiple traverses in concert with one another to sequentially close and open the plurality of mold segment pairs at least once during each traverse.

23. A method according to claim 22, wherein the step of arranging further comprises arranging the pair of circuitous tracks so that the closed mold segment pairs travel generally vertically.

24. A method according to claim 22, wherein the step of arranging further comprises arranging the pair of circuitous tracks so that the closed mold segment pairs travel generally horizontally.

25. A method according to claim 22, wherein the step of arranging further comprises arranging the pair of circuitous tracks such that they generally lie in the same plane and circulate in opposite directions.

26. A method according to claim 22, wherein the step of arranging further comprises arranging the pair of circuitous tracks generally adjacent one another such that they circulate in the same direction.

27. A method according to claim 22, wherein the step of circulating opens and closes the plurality of mold segment pairs in a clam shell manner.

28. A method according to claim 21, further comprising the steps of:
re-opening the closed mold segments; and
discharging a continuous strip of interconnected discrete hollow parts from the mold segments during the step of re-opening.

29. A method according to claim 28, further comprising the step of:
curving the continuous strip of interconnected discrete hollow parts from a discharge direction at a discharge point to a different direction downstream of the discharge point.

30. A method according to claim 21, wherein the step of arranging further comprises arranging the plurality of mold segments to produce a plurality of different discrete hollow part configurations.

31. A method according to claim 21, further comprising the step of:
providing a plurality of different shaped discrete mold cavities to produce a plurality of different discrete hollow part configurations.

32. A method according to claim 21, wherein the step of cooling further comprises:
re-opening the closed mold segments;
discharging a continuous strip of interconnected discrete hollow parts from the mold segments during the step of re-opening; and
subsequently passing the continuous strip of interconnected discrete hollow parts through a cooling element.

33. A method according to claim 32, further comprising the step of:
separating each one of the discrete hollow parts from the continuous strip after the step of cooling.

34. A method according to claim 21, wherein the step of extruding further comprises;
positioning an extrusion die to extrude the molten plastic material into the closed mold segments.

35. A method according to claim 21, where the step of replenishing further comprises:
piercing each discrete hollow part to permit a gas to pass to an interior of each discrete hollow part.

36. A method according to claim 35, wherein the step of piercing further comprises:
providing a needle projecting into each of the discrete mold cavities from the corresponding closed mold segments; and
puncturing each discrete hollow part with the corresponding needle.

37. A method according to claim 35, wherein the step of piercing further comprises:
providing a hollow needle coupled to a source of air and projecting into each of the discrete mold cavities from the corresponding closed mold segments; and
injecting a gas into an interior of each discrete hollow part through the corresponding hollow needle.

38. A method according to claim 37, wherein the step of replenishing is performed by the step of piercing.

39. A method according to claim 21, wherein the step of creating a pressure differential further comprises:
applying a vacuum to each of the discrete mold cavities of the closed mold segments.

40. A method according to claim 21, wherein the step of creating a pressure differential further comprises:
applying a positive pressure to an interior of a discrete hollow part within each of the discrete mold cavities of the closed mold segments.

41. A method according to claim 21, wherein the step of creating a pressure differential also simultaneously performs the step of replenishing.

42. A method according to claim 21, wherein the step of cooling is performed as the discrete hollow parts are being formed in the discrete mold cavities.

43. A method according to claim 42, further comprising the step of:
releasing the discrete hollow parts from the plurality of mold segments after the step of cooling.

44. A method according to claim 21, further comprising the step of:
releasing the discrete hollow parts from the plurality of mold segments before the step of cooling.

45. A method according to claim 21, wherein each of the closed mold segments forms only one of the discrete mold cavities and is capable of forming only an entire one of the discrete hollow parts.

46. A method according to claim 21, wherein each of the closed mold segments forms a plurality of discrete mold cavities and is capable of forming a plurality of entire discrete hollow parts.

47. A method according to claim 46, wherein the step of extruding further comprises:
a plurality of adjacent streams of molten plastic, at least one stream aligned with each of the discrete mold cavities of each of the closed mold segments.

48. A method according to claim 21, wherein each of the closed mold segments forms only a portion of one of the discrete mold cavities and is capable of forming only a portion of an entire one of the discrete hollow parts.

49. A method according to claim 21, adapted to produce a plurality of the discrete hollow parts interconnected in a continuous strip, each part having an exterior wall, a hollow interior, and an interior wall within the hollow interior.

50. A method according to claim 21, wherein the step of extruding further comprises:
extruding at least two discrete streams of molten plastic wherein one stream of the at least two discrete streams is disposed concentric within the other of the at least two discrete streams.

51. A method according to claim 21, wherein the step of extruding further comprises:
extruding at least two discrete streams of molten plastic, each stream comprised of a different plastic material.

52. A method according to claim 21, further comprising the step of:
discharging a continuous strip of interconnected discrete hollow parts from the closed mold segments.

53. A method according to claim 52, wherein during the step of discharging, at least some of the interconnected discrete hollow parts are joined by flexible molded joints so that the continuous strip can curve relative to a longitudinal axis of the continuous strip downstream of a discharge point from the closed mold segments.

54. A method according to claim 50, wherein the during step of discharging, the flexible molded joints are each formed having a plurality of convolutions extending circumferentially around the continuous strip generally between adjacent discrete hollow parts, and having at least one air passage extending longitudinally through each of the molded flexible joints in communication with an interior of the adjacent discrete parts.

55. A discrete hollow part formed by the process according to claim 21.

56. A discrete hollow part according to claim 55, and comprising an interior, a plurality of completely closed walls surrounding the interior, and at least one puncture opening in at least one of the plurality of walls.

57. A discrete hollow part according to claim 55, and comprising an interior, a plurality of wall surrounding the interior, wherein at least one wall has an opening formed therein.

58. A discrete hollow multi-layer part comprising:
a plastic outer skin layer defining a part shape that is non-round in cross-section;
a hollow interior defined within the outer skin layer; and
one or more plastic inner layers formed in the hollow interior of the outer skin layer simultaneous with the outer skin.

59. A part according to claim 58, wherein the outer skin is formed from a first material that is different from a second material that forms the one or more inner layers.

60. A part according to claim 58, wherein the one or more inner layers are formed of a recycled plastic material.

61. A part according to claim 58, wherein the outer skin and the one or more inner layers are formed from the same plastic material, but from different parison streams.

62. A part according to claim 58, wherein the one or more inner layers are formed from a foamed plastic material.
